(19) United States
(12) Patent Application Publication
(10) Pub. No.: US 2024/0017323 A1
(43) Pub. Date: Jan. 18, 2024

(54) PROCESS FOR PRODUCING SHAPED BODIES BY SINTERING

(71) Applicant: Element 22 GmbH, Kiel (DE)

(72) Inventors: Johannes Geronimo SCHAPER, Dannewerk (DE); Manfred JAECKEL, Loxstedt (DE)

(73) Assignee: Element 22 GmbH, Kiel (DE)

(21) Appl. No.: 18/249,127

(22) PCT Filed: Oct. 27, 2021
(86) PCT No.: PCT/EP2021/079821

§ 371 Date: Apr. 14, 2023

(30) Foreign Application Priority Data
Nov. 17, 2020 (EP) 20208200.4

(51) Int. Cl. B22F 3/16; C04B 41/45; C04B 41/48; B22F 3/22; C04B 35/638; C04B 35/645; C04B 35/632; B22F 3/20

(52) U.S. Cl. CPC B22F 3/16; C04B 41/4535; C04B 41/48; B22F 3/22; C04B 35/638; C04B 35/645; C04B 35/632; B22F 3/20; B22F 2201/10; C04B 2235/6026; C04B 2235/616; B22F 2998/10

(57) ABSTRACT

A method for producing a shaped body by sintering including steps of a. providing a starting material containing metal powder and/or ceramic powder, b. forming a green part from the starting material by shaping the starting material if it contains binder material or by introducing a binder material into a powder bed formed from the starting material, c. chemically debinding, and/or debinding by means of a solvent, the green part to obtain a brown part, d. thermally debinding the brown part, e. consolidating the brown part to give the shaped body by sintering. The brown part is treated after step c. and before step d. with a plasticizer that softens the binder material still present in the brown part. Before step d. and after the treatment with the plasticizer, the brown part is subjected to an isostatic pressing operation by contacting with a medium under an elevated pressure.

### TECHNICAL FIELD

The present invention relates to a process for producing a shaped body by sintering. The process is suitable in particular for the powder-metallurgical production of shaped bodies, but can also be used successfully for the production of shaped bodies made of ceramic material with inclusion of sinter compaction and solidification.

### BACKGROUND ART

The production of metal shaped bodies by means of powder-metallurgical methods is a procedure which has been known for a long time and also practiced in mass production. The same applies to the sintering-based production of ceramic shaped bodies. In particular, methods are practiced in which a green part is produced initially from a provided starting material in the form of a mixture of a metal powder or a ceramic powder with binder material, what is known as a feedstock. Alternatively, a starting material containing exclusively metal or ceramic powder can also be arranged in a powder bed and the green part can subsequently be produced by selective introduction of binder material into the powder bed. In both cases, following chemical debinding using a solvent, what is known as a brown part is obtained, which contains only a binder fraction, known as the backbone, which can no longer be removed chemically, by means of the conventionally used solvents, such as acetone, hexane or ethyl acetate, but rather thermally. After thermal debinding, the resulting blank is compressed and solidified in a sintering step. Here, the green part and the brown part generally differ by both the content of binder material in the material scaffold, and by the composition of the binder. Green parts generally contain a higher binder fraction and in any case always also such binder components, for example plasticizers and waxes, which are to be removed chemically by means of a solvent. In addition, however, the green parts also contain a component of a further binder, which is not chemically released but is expelled by heating, i.e., is thermally debound, i.e., the binder which remains in the brown part. Green parts are thus formed from a starting material with a multi-component binder system and the metal or ceramic powder particles.

However, there are also methods in which a brown part is produced immediately, which does not contain any fraction of binder materials that are to be removed chemically by means of solvents. These brown parts are frequently produced from an initial mass, a feedstock, which has a lower fraction of a binder material and normally just one such binder, which is not to be chemically debound using the typical solvents.

The shaping for forming the green part can take place in various ways. In simple variants, this is achieved by simple press molding in press molds, from which the molded parts are removed, initially chemically, then thermally debound and finally sintered. However, other shaping methods are also possible, for example MIM (Metal_Injection Molding), slip casting, extrusion or, increasingly, also additive shaping methods such as the 3D printing method.

Whereas initially mainly steel with a different alloy, but also copper and bronze, was used for the powder-metallurgical production of shaped bodies, the focus is more recently also on the processing of metals which are significantly more reactive and in particular react more strongly with oxygen, compared with the mentioned metals, which more reactive metals are referred to as reactive metals. These metals referred to here as reactive metals include in particular titanium or titanium alloys, aluminum or aluminum alloys, and magnesium or magnesium alloys. For example, in the field of medical technology, but also in other industrial sectors, various components are produced nowadays by powder metallurgy from titanium or titanium alloys, for example housings for implantable insulin pumps or the like.

A challenge in the case of the sintering-based production of shaped bodies in which the shaped bodies are compacted in a sintering step consists, in addition to taking into account the material shrinkage during sintering, in the achievement of a desired high material density and strength of the sintered part. This is because firstly the starting material is interspersed with pores before sintering, and sometimes also with defects. These pores and defects have two mechanisms of origin:

Firstly, in the course of the shaping of the green part, process-related gaps, usually larger pores, also referred to as macropores, or transverse elements occurring due to delamination, can already arise in the material framework, due to insufficient filling of the space enclosed by the green parts with the starting material in the shaping process, or else due to an insufficient connection of layers of powder applied in layers. Such defects can occur both in the case of additive manufacturing methods, such as 3D printing, and in a pressing operation, but also in MIM, during slip casting or during extrusion.

Secondly, process-related micropores form when first the green part, then also the brown part, is debound. Where binder particles were initially arranged, these micropores arise between the otherwise tightly packed metal particles.

While the micropores which arise during debinding can generally be closed by suitable parameter selection of the sintering process, the material can be compressed to a high degree in the sintering operation, the defects already arising in the shaping process of the green part, such as the macropores or transverse elements, represent a greater problem. This is because they can often no longer be completely closed, even in a sintering operation subsequent to the thermal debinding. While the above-mentioned micropores likewise cannot be closed by relocating the powder particles, they are unavoidable in the green part or the brown part as free spaces between tightly packed powder particles lying close to one another, and are closed only during the sintering operation due to deformation of the powder particles which occur there and the diffusion processes connecting the powder particles, the defects, such as macropores or transverse elements, can be made in such a way that they can be filled in principle by relocation of the powder particles. At the positions of such defects, there is quasi a “lack” of one or even multiple powder particles of the material powder used.

In order to now eliminate the defects which are not to be closed during the sintering operation, sintered components are subjected to further treatment steps carried out after the sintering process, in order to further increase the material density and to close the remaining macropores, in particular if it is important that the component should be compact and there should be a high density, i.e., a low porosity, of the finished part. What is known as hot isostatic pressing (HIP) is frequently used here, which is applied to the already compacted shaped bodies obtained after the sintering process. In this case, the finished sintered shaped bodies are exposed to a medium under high pressure, typically an inert gas, in a treatment space, and at the same time exposed to a high temperature. Depending on the metal or ceramic material processed, high pressures, typically 1000 bar and higher, often up to several 1000 bar, are required here, as well as high temperatures, typically several 100° C., not infrequently up to more than 1000° C.). In the processing of reactive metals, high demands are also made on the purity of the pressing medium in order to avoid contamination of the components, in particular by reaction with oxygen. Not least, these requirements of the process conditions make the hot isostatic pressing a complicated and costly method, for which there are only a few suppliers on the market. In addition, it is not ensured for all materials that hot isostatic pressing of the sintered shaped body can be carried out at all.

Firstly, plants for this method step must still be designed and constructed in such a way that they reliably withstand the high pressures, and no accidents, which are devastating at these high pressures, can occur. Secondly, the generation of such high pressures and high temperatures is energy-intensive. In this case, it is also found that the defects which are initially closed under the high applied pressure can, in many cases, be opened again after the hot isostatic pressing due to the expanding gas, which is trapped in the interior thereof, under thermal stress on the shaped part, such that in any case a part of the pores is formed again in a kind of restoring effect. Finally, the high pressure to be set for the hot isostatic pressing, typically in the range from 1000 to 2000 bar, requires the use of a large quantity of the process medium, for example a gas, which, especially when the process medium has to meet extremely high demands for the purity, has a significant influence on the costs of the method.

If, moreover, the defects to be closed, such as macropores, are not enclosed in the interior of the shaped body, but are open to the outside, a sealing of the defects cannot be achieved by means of hot isostatic pressing. This is because the medium under pressure, for example an inert gas such as argon, also penetrates into the open defects and keeps them open. This is of particular relevance since, in the case of some additive manufacturing methods, such as 3D printing methods during layer-by-layer application of the material, e.g., during printing, a kind of delamination can occur between the layers, which is sometimes visible only during the debinding or even only during sintering. Such a delamination, which constitutes a significant deficiency of the shaped part, may, however, sometimes still not become clearly apparent after sintering, but has consequences only when the shaped part is subjected to mechanical stress. These defects which occur on the surface of the shaped part and/or which extend as far as the surface of the molded part, and can be traced back to a delamination, have a particularly high influence on what is known as the alternating load, especially in the case of dynamic loading of the shaped part. In the worst case, this can lead to failure of a shaped part produced in this way, also in critical application situations.

Furthermore, methods have been described in which a compaction of the still unfinished component takes place after the shaping process and prior to sintering, by means of application of pressure. For example, EP 995 525 A1 describes a procedure in which, for example using MIM, a green part is produced, said green part is debound and subsequently sintered, the green part or the debound green part being compressed by application of a pressurized inert gas, such as argon. The method disclosed therein provides for the application, to the green part, of a comparatively high pressure of at least 1000 bar, even significantly higher in many described experimental examples, which makes this procedure complicated in terms of apparatus and costly.

DE 10 2018 129 1 62 A1 describes a procedure in which a shaped body is firstly formed from a mixture of a binder with a ceramic granulate, in an additive manufacturing method, as a green part, the green part is then partially debound, then sintered at a significantly elevated temperature for a certain duration, and subsequently painted. The green part, partially debound and sintered and painted in this way is then compacted in a cold wet isostatic pressing operation. Subsequently, the paint applied before the cold wet isostatic pressing is removed, and the green part is debound and then sintered. A pressure to be used for the cold wet isostatic pressing according to the teaching of this document is not disclosed.

US 201 7/088471 A1 describes a method for producing ceramic components in a cold sintering method. In particular, the production of laminated composite components, which can be formed from different ceramic layers, is also described. Said components can be laminated, i.e., connected to one another, by application of pressure, before the actual cold sintering.

### SUMMARY OF THE INVENTION

In this case, the invention aims to provide a remedy by specifying a process or method for producing a shaped body, incorporating a sintering step, which method allows for defects, such as macropores or transverse elements, to already be reduced or closed before the sintering step, and thus improves the material density obtained by the sintering, and thus eliminates the need for post-treatment, such as hot isostatic pressing, which takes place only after the sintering.

This object is achieved according to the invention by a method for producing a shaped body by sintering, comprising the steps of a. providing a starting material containing a metal and/or ceramic powder, b. forming a green part from the starting material either by shaping the starting material if it also contains a mixture of the metal and/or ceramic powder and binder material, or by introducing a binder material into a powder bed formed from the starting material, c. chemically debinding, and/or debinding by means of a solvent, the green part to obtain a brown part, d. thermal debinding of the brown part obtained in step c, e. consolidating the brown part to give the shaped body by sintering, characterized in that after step c. and before step d., the brown part is initially treated with a plasticizer that softens the binder material still present in the brown part and not removed by the prior chemical debinding and/or debinding by means of a solvent in step c., and furthermore, before step d. and after the treatment with the plasticizer, it is subjected to an isostatic pressing operation by application of a medium under an elevated pressure. Advantageous developments of the method according to the invention include that the treatment of the brown part may be carried out using a liquid plasticizer, in particular by dip treatment. The method may further be characterized in that the isostatic pressing operation may be carried out at a temperature increased relative to room temperature, in particular at a temperature in the range from 30° C. to 200° C. The method may further be characterized in that the isostatic pressing operation may be carried out by applying a medium under a pressure of >60 bar, preferably >80 bar, in particular >100 bar, but also <500 bar, in particular <300 bar. The method may further be characterized in that a gas, in particular an inert gas, or a liquid, may be used as the medium under elevated pressure. The method may further be characterized in that after the treatment with the plasticizer and before the application of medium under an elevated pressure, the brown part may be provided with a coating, in particular a polymer coating, which surrounds the outer surfaces of the brown part. The method may further be characterized in that the coating may be formed from a material that may be separated chemically and/or in a solvent-based manner and/or thermally. The method may further be characterized in that the coating may be formed from a material that can be separated thermally, mechanically, chemically and/or in a solvent-based manner, and in that after the isostatic pressing operation and before step d. the coating may be removed thermally, mechanically, chemically and/or using a solvent. The method may further be characterized in that the plasticizer introduced into the brown part after step c. and before step d. may be removed after the isostatic pressing operation is carried out by applying a medium under an elevated pressure to the brown part, and before the sintering step e., in particular before step d. The method may further be characterized in that the shaping of the green part or the brown part in step b. may be carried out by an additive shaping method. The method may further be characterized in that the shaping of the green part or of the brown part. The method may further be characterized in that carried out in step b. by means of MIM, by means of slip casting, by extrusion or by a compression molding operation. The method may further be characterized in that the shaped part may be produced by powder metallurgy and, in step a., a starting material containing metal powder may be provided. The method may further be characterized in that a powder of a metal that is more reactive compared with steel, in particular titanium powder, a titanium alloy powder, aluminum powder, an aluminum alloy powder, magnesium powder or a magnesium alloy powder, is used as the metal powder. The method may further be characterized in that the metal powder may contain a hard metal powder. The method may further be characterized in that a ceramic shaped part may be produced, and, in step a., a starting material containing ceramic powder may be provided.

In this case, a method according to the invention for producing a shaped body by sintering firstly, as is also customary in the prior art, includes the following steps:
a. providing a starting material containing a metal and/or ceramic powder,
b. forming a green part from the starting material either by shaping the starting material if it also contains a mixture of the material powder and binder material, or by introducing a binder material into a powder bed formed from the starting material,
c. chemical debinding and/or debinding by means of a solvent, of the green part, in order obtain a brown part,
d. thermal debinding of the brown part obtained in step c,
e. consolidating the brown part to form the shaped body by sintering.

As already mentioned, these method steps are also customary in the production methods for shaped bodies known from the prior art, which shaped bodies are produced by means of a powder-metallurgical or sinter-based method, from ceramic powders. The particular feature of the method according to the invention is that, after step c. and before step d., the brown part is initially treated with a plasticizer that softens the binder material still present in the brown part and not removed by the prior chemical debinding and/or debinding by means of a solvent in step c., and furthermore, before step d. and after the treatment with the plasticizer, it is subjected to an isostatic pressing operation by application of a medium under an elevated pressure.

Thus, in the method according to the invention, before the final sintering step is carried out, the shaped part formed from the material powder held together with binder is consolidated in an isostatic pressing operation, in order in particular to close defects resulting in the shaping operation carried out under step b., such as macropores or other defects in the material structure, optionally also to close macropores formed by chemical debinding of the green part. In this case, since the pressing operation is carried out isostatically, the pressure acts on all sides on the shaped part and thus leads to a uniform compression without causing the risk of an in particular one-dimensional change in the given shape of the shaped body. In this case, the pressing operation is carried out in particular with a demolded “exposed” shaped part. Due to the consolidation achieved by this step, the individual particles of the powder material, i.e., of the metal and/or ceramic powder, can be connected to one another particularly successfully in the sintering step carried out subsequently, without the formation of large numbers of undesirable macropores or other defects for example. It is true that a consolidation carried out by isostatic pressing by application of a medium under pressure even before the final sintering step is already known and described. However, this requires, in the known methods, the application of a high pressure and a procedure in a complicated method sequence. These disadvantages known from the prior art are avoided in the method according to the invention in that, after step c. and prior to carrying out the isostatic pressing, the brown part is treated with a plasticizer which is still present in the brown part and softens the binder material not removed by the prior chemical debinding and/or debinding by means of a solvent in step c. In the binder material of the green part, the plasticizer provides an increase in the ductility of this binder material. Thus, a consolidation of the material in the brown part can be obtained with a comparatively low applied pressure of, in particular, no more than 500 bar, which then nonetheless results in the shaped body having a particularly high material density after sintering. Post-treatment of the shaped body after sintering, in order to increase its material density, as is frequently undertaken in the prior art, for example, and in particular by hot isostatic pressing (HIP) of the finished metal part, is therefore not necessary. Furthermore, in the case of shaped bodies subjected to hot isostatic pressing (HIP) after sintering, in the case of a subsequent heat treatment or loading (in particular alternating load) of the shaped body, the pores compressed and closed in the HIP method can open again if they still contain gas inclusions, in particular if they were not sintered under vacuum conditions. This effect is not observed in a procedure according to the invention, since the macropores are already eliminated prior to sintering. Thus, no large-volume gas inclusions exist after sintering.

Therefore, since in the isostatic pressing, according to the invention, of the not yet sintered brown part, there is still no material bond between the powder particles, only the mixture of the binder previously softened by the plasticizer, and the material powder, must be deformed and compressed, the pressing can take place at a much lower pressure than is necessary during the hot isostatic pressing (HIP) taking place after sintering. It is also not necessary to increase the temperature to several 100° C. up to above 1000° C., as is usual and necessary in hot isostatic pressing (HIP) of the finished sintered molded part. This results not only in a considerably lower energy requirement for such an isostatic pressing operation according to the invention that is carried out on the non-sintered molded part, compared to the energy requirement during hot isostatic pressing (HIP) carried out after sintering. The outlay in terms of apparatus required for the step of isostatic pressing of the not yet sintered brown part is also considerably lower than that for the hot isostatic pressing (HIP) carried out after sintering, but also than that required by the pressing and consolidation method, known from the prior art, carried out prior to the final sintering. In particular, due to the lower pressure to be applied and also the lower temperatures, far lower safety requirements are imposed on the apparatus in which the isostatic pressing operation according to the invention is to be carried out on the brown part treated with the plasticizer.

The plasticizer used, according to the invention, for softening the binder material in the brown part can advantageously be selected such that it is likewise removed and discharged, ideally in a debinding step(s) provided in any case, before the actual sintering operation. The typical and known plasticizers are possible as plasticizers here, which plasticizers are effective and can be used for the binder systems known per se and the polymers used therein, such a plasticizer, can, for example, also be water if, for example, polyamides are used as binder components. Ideally, such plasticizers should be volatilized at the latest at those temperatures which are provided for thermal debinding in the powder-metallurgical production method, or be expelled from the brown part or from the part to be sintered at these temperatures. It is also conceivable to remove a used plasticizer in a chemical and/or solvent-based step.

The use of a plasticizer may also be advantageous from another perspective: Specifically, a plasticizer can also impair an “adhesive effect” of the binder, can increase the “stickiness” of the binder. This can help to close and keep closed the defects in the case of the isostatic pressing of the brown part described here, since the binder then holds together the cavities, once closed, by its cohesive force.

The amount of the plasticizer required for sufficient softening of the binder material still remaining in the brown part is comparatively low, depending on the effectiveness of the plasticizer. It is in any case substantially lower than the amount of plasticizers which, for example for a flowability necessary for thermoplastic shaping, may be added to the original binder system used for the production of the green part. However, such an originally added plasticizer is discharged in step c., and is no longer present in the subsequently obtained brown part. Accordingly, the technological properties of the brown part required for the subsequent isostatic pressing operation, in particular those of the binder material softened by the plasticizer, can also be adjusted according to the requirements by the addition of plasticizer which took place after step c. (optionally addition again) of plasticizer via the selection of the plasticizer and the metering thereof.

The amount of plasticizer introduced and the working conditions which can be changed therewith at temperature and pressure can be adjusted by a single or multiple treatment, and likewise by the selection of the plasticizer. The strongest influence on the softening of the binder material, also referred to as a backbone, still remaining in the brown part can be achieved when primary plasticizers are used, which can have very different chemical structures in the chemical composition depending on the chemical composition of a polymer binder material used.

Primary plasticizers are understood to mean substances which soften the polymer even in low concentrations. In the case of a polyamide system to be used advantageously as binder material for the backbone, the values of the introduced plasticizer are, based on the polymer fraction, for example in the range from 1 5 to 30 wt. %.

In a specific example, this can mean, in the case of a green part comprising 12 wt. % binder in a titanium-based feedstock having a polymer content of 30% in the binder, that 3.2 wt. % polymer remains in the brown part after complete extraction of the soluble components. This then means an intake of 0.56 to 1 4 wt. % plasticizer in order to make the brown part sufficiently ductile for the subsequent isostatic pressing operation.

As already mentioned, the amount and composition of the plasticizer used for the isostatic pressing operation in the brown part can be completely different from that for a preceding shaping process for the green part. Compared to a consolidation of the green part with a same approach, isostatic pressing of the brown part also has the advantage, in particular, that a kind of flexible sponge structure is formed in the brown part treated with the plasticizer, which can be consolidated significantly better than a green part. In addition, the applied pressure is distributed significantly more homogeneously within the brown part softened by means of the plasticizer, and no local pressure nests occur after the expansion, which would arise from an isolated pore.

The brown part can in particular be treated using a liquid plasticizer. This can take place, for example, in the form of a dipping treatment, i.e., in the manner of impregnation.

In this case, according to the invention, the introduction of the plasticizer into the brown part can be very advantageously achieved if the plasticizer is previously dissolved in a solvent which is absorbed very easily by the porous shaped part structure of the brown part. It is advantageously possible here to use the same solvents which are also used in step c. for the chemical or solvent-based (pre-)debinding of the green part to the brown part. In the case of use of polyamide-based binder systems, these can be, for example, solvents such as acetone, hexane, or ethyl acetate.

If the plasticizer is distributed in the solvent in concentrations of, for example, 10 to 30% by weight, very low viscosities can be achieved, such that such a mixture can diffuse completely into the porous structure of the brown part, depending on the wall thickness of the brown part, within for example 30 to 60 minutes.

In the isostatic pressing operation to be carried out according to the invention before the sintering step, a temperature increased with respect to the normal temperature can be applied, in order in particular to soften the binder material and to make it flowable or plastically deformable to a certain degree. In this case, for example temperatures in the range from 30° C. to 200° C. are typically sufficient for the polymer materials typically used as binder materials or combined in binder systems in the case of the powder-metallurgical production methods. Due to the typically significantly lower temperature during the pressing operation, the isostatic pressing carried out according to the invention before the sintering can also be referred to, if a temperature increase is provided, as warm isostatic pressing (WIP), as distinct from the known hot isostatic pressing (HIP) carried out on the finished sintered shaped body.

The pressure selected for the isostatic pressing operation carried out according to the invention before the sintering step, which pressure the medium used for application to the brown part is under, is, as mentioned, typically significantly below that pressure which is used for hot isostatic pressing (HIP) carried out after the sintering step in the prior art, and can in particular be in the region of >60 bar, preferably >80 bar, in particular >100 bar. Even if, in principle, significantly higher pressures can also be selected, in particular when working at lower temperatures, they will not be set in practice, in particular in order for the complicated and expensive apparatuses for safe control of such high pressures, as are used in hot isostatic pressing, not to be required. Accordingly, in the method according to the invention, generally no pressures above 500 bar are selected, usually even pressures of below 300 bar.

In principle, all possible media, i.e., finely particulate solid particles, liquids or gases, are possible as the medium which is applied to the brown part. Preferably, a liquid or alternatively a gas is selected as the medium. It must be ensured here that the selected medium does not interact in an undesired manner, in particular does not enter into any undesired chemical reactions or form residues and inclusions, under the given conditions of pressure and temperature during the pressing operation, with the material system of the shaped part, in particular with the metal powder in the case of a shaped part to be produced by powder metallurgy, but also generally with the binder. The pressing operation according to the invention, to be carried out before the sintering step, can be carried out, for example, by introducing water as a medium. Preferably, however, gases, in particular inert gases, can also be used, for example argon or nitrogen.

In particular, when the defects to be closed by the pressing operation to be carried out according to the invention before the sintering step are open, i.e., have a connection through the surface of the shaped part to the outside, or if, for example, defects to be observed in a surface connection (delamination), after shaping in the additive manufacturing method such as 3D printing, are to be eliminated, it is expedient and is provided in an advantageous development according to the invention that the brown part is provided with a coating, in particular a polymer coating, which surrounds the outer surface of the shaped part, after the treatment with the plasticizer and before the application with the pressurized medium. Such a coating can be applied, for example, in a dipping operation in which the brown part is immersed in a bath of a liquefied coating material, for example a polymer, and the coating subsequently solidifies. However, other application methods, such as spraying methods or an application using an application tool similar to those for paints or dyes are also conceivable. Enclosing with a film or the like, for example welding into such a film or comparable enveloping, is also possible. Such an applied coating closes gaps and openings existing on the surface of the brown part, for example in an open pore system, such that such defects can also be compressed and closed by applying the pressurized medium. Moreover, this coating also forms a protection around the shaped part, such that, when a medium which can react with the components of the brown part or any residues of which could influence the sintering process in a harmful manner, is used, contact of this medium with the brown part can be prevented. For example, the use of water as a medium can be made possible when such a coating is water-resistant and can be removed after the pressing operation to be carried out before the sintering step, without water residues in a non-desired form coming into contact with the brown part, accumulating there, or even reacting and being able to introduce oxygen into the shaped body.

The coating applied according to the above-described development can be formed in particular from a material that can be separated chemically and/or in a solvent-based manner and/or thermally. However, if, for example, a film or a comparable casing-like coating is used, it can also be mechanically removable. If the coating is thermally separable, it can, for example, be thermally debound or removed in a uniform process together with the binder material (the backbone) of the binder system that holds the green part together before the sintering operation. However, the coating is preferably formed from a material that can be separated chemically and/or by a solvent, so that the coating can be removed chemically and/or by use of a solvent after the isostatic pressing operation and before the sintering step. In this way, the fraction of in particular organic material, which, in the case of subsequent thermal debinding, which regularly takes place in a continuous processing step with subsequent sintering operation, can be reduced, so that contamination of the shaped body can be avoided, at least reduced, by incorporation of, for example, carbon from the coating material. In such a procedure, the plasticizer introduced into the brown part according to the invention can also be removed again, for example washed out with a solvent.

However, it is also conceivable for a coating to be separated in another way, for example by means of applying a negative pressure, by means of vacuum.

After the coating is removed again after the isostatic pressing operation, a pressure equalization can take place in which gas can escape from the consolidated brown part. The ambient pressure then prevails there. This further leads to any restoring effects in which closed pores are opened again by an overpressure still prevailing there being suppressed.

The shaping of the green part or brown part in step b. of the method according to the invention can preferably be carried out by an additive shaping method, such as by 3D printing. However, it can also be achieved by MIM, slip casting, extrusion or by a compression molding operation.

The method according to the invention can be carried out as a powder-metallurgical method and, in this case, in principle with all possible metals and metal alloys, for example with steel, as well as stainless steel, bronze, copper and the like. In particular, however, it is also very suitable for the powder-metallurgical production of shaped bodies from a metal, which is significantly more reactive compared to steel, referred to here as “reactive,” such as titanium, a titanium alloy, aluminum, an aluminum alloy, magnesium or a magnesium alloy, for which such a reactive metal, such as titanium powder, a titanium alloy powder, magnesium powder or a magnesium alloy powder, is accordingly used as the metal powder. However, the method according to the invention can also be applied to other reactive metals such as what are known as superalloys based on nickel or cobalt, and to the refractory metals molybdenum, tungsten, rhenium, and tantalum. In particular, non-noble metals are referred to here as “reactive metals,” in particular those having a standard potential E° of <−1.0 V. The method according to the invention can also be used for the production of shaped parts made of hard metals or of a material having a metal or ceramic base matrix and particles made of hard metal, such as tungsten or cobalt carbide, embedded therein. Likewise, the method according to the invention can also be used for the sintering-based production of ceramic shaped bodies, green or brown parts containing ceramic powder and binder then being formed and being treated by the warm isostatic pressing, disclosed here, prior to sintering.

As a result of the warm isostatic pressing according to the invention prior to the sintering step, not only can the defects obtained in the shaping method be closed, but a first consolidation of the brown part can also already take place, when pressure and temperature are set appropriately, that is to say an increase in the packing density of the material powder particles in the volume, and thus a first reduction of the microporosity even before the actual sintering.

### BRIEF DESCRIPTION OF THE DRAWINGS

The efficacy of the invention was demonstrated by the inventor in experiments. Among other things, the inventor carried out and evaluated as described the experiment described in the following and illustrated in greater detail in the accompanying drawings, and explained in the results. In the figures:

FIG. 1 shows, in a schematic view, the procedure according to the invention when carrying out the method step referred to here as warm isostatic pressing, in the experiment carried out, and

FIG. 2 shows, in a bar chart, a comparison of the determined porosity of sintered shaped parts produced by a method according to the invention with the determined porosity of the reference shaped parts produced identically except for the warm isostatic pressing not carried out.

### DETAILED DESCRIPTION

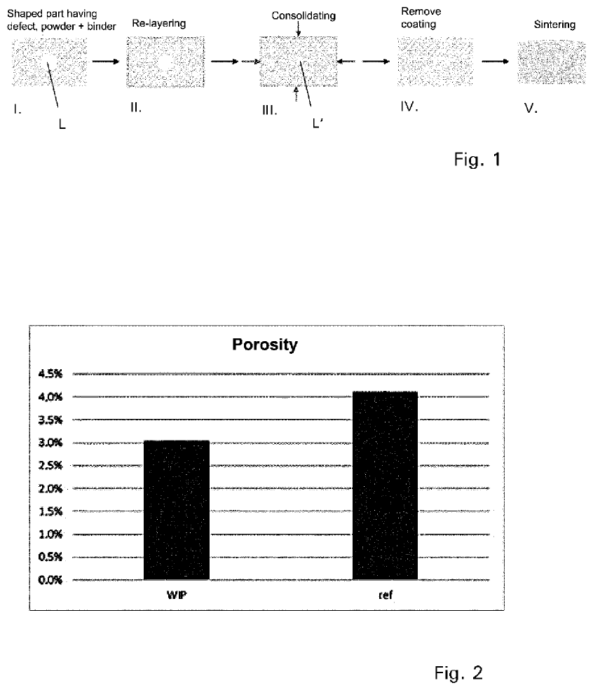

In order to carry out the experiment, a plate of approximately 5 mm in height was pressed from a Ti6Al4V powder and a starting material containing a binder system formed on the basis of polyamide, a feedstock, and subsequently sawn into strips or bars. These bars contained air inclusions, known as cavities. This is shown in the depiction of FIG. 1 denoted by I, where a cavity is denoted by L.

The obtained bars were solvent-debound in acetone. One half of the bars (WIP) was then infiltrated with a mixture of acetone and plasticizer. After drying, the bars thus treated were wet-coated with a mixture of acetone and an acetone-soluble polymer, and dried again. After this second drying operation, a coating made of the polymer remained on the outer surfaces of the bars thus treated. This is shown in illustration II of FIG. 1.

The remaining half of the bars remained as a reference.

The first half of the bars coated with the polymer were subjected to a pressing operation according to the invention, carried out before a sintering step (warm isostatic pressing, WIP). This WIP treatment was carried out by application of argon at a pressure of 90 bar and at initially about 160° C. The pressure was then maintained, while the temperature was lowered. This WIP treatment is shown in illustration III of FIG. 1. After this treatment, the bars thus treated were again debound in acetone in order to remove the plasticizer and the polymer coating again (cf. illustration IV in FIG. 1).

Subsequently, the bars subjected to the WIP treatment and the untreated bar kept as a reference were sintered in a common furnace run. This is illustrated in the illustration V of FIG. 1. A density determination according to the Archimedes principle was carried out on the sintered components. The measurement results were averaged and the average values are plotted in FIG. 2. These results show that the porosity of those bars which were treated by the method described above and according to the invention, represented by the bar denoted WIP, is approximately 1% lower than the porosity of the non-treated reference bars, represented by the bar denoted ref. It therefore follows that the cavities L, which are initially present in both bar groups, were able to be reduced in volume or even completely closed in the WIP-treated group of the bars. This is illustrated in FIG. 1 by the cavity L′ that is shown smaller.

It should be pointed out once again at this point that the experiment described above and illustrated in the figures merely represents a possible procedure for carrying out the method according to the invention. In particular, the method is not limited to powder-metallurgical production methods, and in particular not to those with the alloy specifically used in the experiment, but can also be carried out just as successfully with ceramic material. The coating of the shaped part selected in the experiment, before the WIP treatment, is also not absolutely necessary. This coating is optional and is selected by a person skilled in the art when it is advantageous, as set forth in the above description. What is decisive is solely the fact that a treatment step referred to here as warm isostatic pressing is carried out on the green part and/or the brown part before the sintering step, in order to thus already obtain an increase in the material density before the sintering.

1. A method for producing a shaped body by sintering, comprising steps of:
a. providing a starting material containing a metal and/or ceramic powder;
b. forming a green part from the starting material either by shaping the starting material if the starting material contains a mixture of the metal and/or ceramic powder and binder material, or by introducing a binder material into a powder bed formed from the starting material;
c. chemically debinding and/or debinding the green part by means of a solvent T part to obtain a brown part;
d. thermally debinding the brown part obtained in step c;
e. consolidating the brown part to give the shaped body by sintering;
wherein after step c. and before step d., the brown part is initially treated with a plasticizer that softens the binder material still present in the brown part and not removed by the prior chemical debinding and/or debinding by means of the solvent in step c., and furthermore, before step d. and after the treatment with the plasticizer, the brown part is subjected to an isostatic pressing operation by application of a medium under an elevated pressure.

2. The method according to claim 1, wherein the treatment of the brown part is carried out using a liquid plasticizer.

3. The method according to claim 1, wherein the isostatic pressing operation is carried out at a temperature increased relative to room temperature.

4. The method according to claim 1, wherein the isostatic pressing operation is carried out by applying the medium under the elevated pressure of >60 bar.

5. The method according to claim 1, wherein a gas or a liquid, is used as the medium under the elevated pressure.

6. The method according to claim 1, wherein after the treatment with the plasticizer and before the application of the medium under the elevated pressure, the brown part is provided with a coating which surrounds outer surfaces of the brown part.

7. The method according to claim 6, wherein the coating is formed from a material that can be separated one of chemically, thermally and with a second solvent.

8. The method according to claim 6, wherein the coating is formed from a material that can be separated one of thermally, mechanically, chemically and with a second solvent, and in that after the isostatic pressing operation and before step d. the coating is removed one of thermally, mechanically, chemically and using the second solvent.

9. The method according to claim 1, wherein the plasticizer introduced into the brown part after step c. and before step d. is removed after the isostatic pressing operation is carried out by applying the medium under the elevated pressure to the brown part, and before the sintering step e.

10. The method according to claim 1, wherein the shaping of the green part or the brown part in step b. is carried out by an additive shaping method.

11. The method according to claim 1, wherein the shaping of the green part or of the brown part is carried out in step b. by means of one of Metal Injection Molding (MIM), slip casting, extrusion, and a compression molding operation.

12. The method according to claim 1, wherein the shaped part is produced by powder metallurgy and, in step a., a starting material containing metal powder is provided.

13. The method according to claim 12, wherein the metal powder that is more reactive compared with steel, and is one of a titanium powder, a titanium alloy powder, an aluminum powder, an aluminum alloy powder, a magnesium powder and a magnesium alloy powder.

14. The method according to claim 12 wherein the metal powder contains a hard metal powder.

15. The method according to claim 1, wherein a ceramic shaped part is produced, and, in step a., a starting material containing ceramic powder is provided.

16. The method according to claim 3, wherein the temperature at which the isostatic pressing operation is carried out is in a range of from 30° C. to 200° C.

17. The method according to claim 4, wherein the isostatic pressing operation is carried out by applying the medium under the elevated pressure of <500 bar.

18. The method according to claim 5, wherein the gas is an inert gas.

19. The method according to claim 6, wherein the coating is a polymer coating.

20. The method according to claim 9, wherein the plasticizer introduced into the brown part after step c. and before step d. is removed after the isostatic pressing operation is carried out by applying the medium under the elevated pressure to the brown part, and before step d.
